(19) United States
(12) Patent Application Publication
(10) Pub. No.: US 2016/0002527 A1
(43) Pub. Date: Jan. 7, 2016

(54) Phosphor-Containing Curable Silicone Composition and Curable Hotmelt File Made Therefrom

(71) Applicant: DOW CORNING KOREA LTD., Seoul (KR)

(72) Inventor: Sun-Hee Kim, Uijeongbu-si (KR)

(21) Appl. No.: 14/768,865

(22) PCT Filed: Feb. 19, 2014
(86) PCT No.: PCT/KR2014/001337

§ 371 Date: Aug. 19, 2015

(30) Foreign Application Priority Data
Feb. 19, 2013 (KR) 10-2013-0017438

(51) Int. Cl. C09K 11/02; C09K 11/77

(52) U.S. Cl. CPC C09K 11/025; C09K 11/7706

(57) ABSTRACT

A phosphor-containing curable silicone composition giving a curable hotmelt film and the curable hotmelt film used for light-emitting semiconductor device are provided. The composition containing the phosphor gives a tack free film at room temperature by half cure and the film is easy to fabricate the desired forms. The fabricated film is easy to pick up them from the support substrate and transferred onto a light emitting semiconductor device at room temperature. The laminated film is molten followed by cured by heating to give excellent permanent adhesion to the device surface.

### TECHNICAL FIELD

The present invention relates to a phosphor-containing curable silicone composition capable of forming a curable hotmelt film, and to a curable hotmelt film made therefrom and used for a light-emitting semiconductor device.

### BACKGROUND ART

Curable silicone compositions are known for their excellent properties, such as resistance to heat and to cold, electrical insulation properties, weatherproof properties, repellency of water, transparency, etc. Due to these properties, the compositions find wide application in various industries. Since the compositions are superior to other organic materials with regard to their color change and deterioration of physical properties, one can expect that such compositions will find use as a material for optical parts. For example, US Patent Application Publication No. 2004/116640A1 discloses an optical silicone resin composition for light-emitting diodes (LEDs) that is composed of an alkenyl-containing silicone resin, an organohydrogenpolysiloxane, and an addition-reaction catalyst.

In the field of LEDs, the use of phosphors for wavelength conversion is well known. A method is generally used in which a liquid curable silicone composition with a phosphor dispersed therein is dispensed onto a LED chip followed by cure. The coverage of the LED chip with cured silicone layer containing phosphor enables conversion from blue light emitting from LED chip to white light. However, such a method has a problem in color variation mainly caused by lack of uniformity in the phosphor dispersion. In order to achieve such uniform dispersion, phosphor containing sheets are under investigation, for example US Patent Application Publication No. 2008/308828A1 discloses an phosphor-containing adhesive silicone composition and composition sheet formed of the composition, but this method has other problems, including deformation of sheet in the sheet fabrication and poor adhesion to the textured LED chip surface.

### DISCLOSURE OF INVENTION

### Technical Problem

It is an object of the present invention to provide a phosphor containing curable silicone composition capable of forming a hotmelt film having residual hydrosilylation reactivity for full cure. And it is another object of the present invention to provide the hotmelt film used for light-emitting semiconductor device.

### Solution to Problem

A phosphor-containing curable silicone composition comprising:

(A) an alkenyl group-functional organopolysiloxane which consisting of

78 to 99% by mass of (A-1) an organopolysiloxane resin represented by the following average unit formula (1):

(R¹R²₂SiO_{1/2})ₐ(R²₃SiO_{1/2})_{b}(R²₂SiO_{2/2})_{c}(R²SiO_{3/2})_{d}(SiO_{4/2})ₑ(R³O_{1/2})_{f} (1)

wherein R¹ is an alkenyl group having 2 to 10 carbon atoms; R² is an alkyl group having 1 to 10 carbon atoms, a cycloalkyl group having 3 to 10 carbon atoms, or an aryl group having 6 to 12 carbon atoms, with the proviso that at least 40 mol % of R² are aryl groups; R³ is a hydrogen atom or an alkyl group having 1 to 10 carbon atoms; “a” is a number of 0.1 to 0.4, “b” is a number of 0 to 0.3, “c” is a number of 0 to 0.3, “d” is a number of 0.4 to 0.9, “e” is a number of 0 to 0.2, “f” is a number of 0 to 0.05, with the proviso that the sum of “a” to “e” is 1;

1 to 7% by mass of (A-2) an organopolysiloxane resin represented by the following average unit formula (2):

(R⁵₃SiO_{1/2})_{g}(R⁴R⁵SiO_{2/2})ₕ(R⁵₂SiO_{2/2})ᵢ(R⁵SiO_{3/2})ⱼ(SiO_{4/2})ₖ(R⁶O_{1/2})ₗ (2)

wherein R⁴ is an alkenyl group having 2 to 10 carbon atoms; R⁵ is an alkyl group having 1 to 10 carbon atoms, a cycloalkyl group having 3 to 10 carbon atoms, or an aryl group having 6 to 12 carbon atoms, with the proviso that at least 40 mol % of R⁵ are aryl groups; R⁶ is a hydrogen atom or an alkyl group having 1 to 10 carbon atoms; “g” is a number of 0 to 0.2, “h” is a number of 0.05 to 0.3, “i” is a number of 0 to 0.3, “j” is a number of 0.4 to 0.9, “k” is a number of 0 to 0.2, “l” is a number of 0 to 0.05, with the proviso that the sum of “g” to “k” is 1;

0 to 15% by mass of (A-3) an organopolysiloxane represented by the following average formula (3):

R⁷₃SiO—(R⁷₂SiO)ₙ—SiR⁷₃ (3)

wherein R⁷ is an alkenyl group having 2 to 10 carbon atoms, an alkyl group having 1 to 10 carbon atoms, a cycloalkyl group having 3 to 10 carbon atoms, or an aryl group having 6 to 12 carbon atoms, with the proviso that at least two R⁷ in a molecule are alkenyl groups, at least 30 mol % of R⁷ are aryl groups; and “n” is an integer of 4 to 100;

(B) an organohydrogenpolysiloxane having two hydrogen atoms each directly bonded to silicon atoms in a molecule, in an amount that component (B) gives 0.5 to 10 silicon atom-bonded hydrogen atoms per one alkenyl group in component (A);

(C) a hydrosilylation catalyst in a sufficient amount to conduct a hydrosilylation of the composition; and

(D) a phosphor in an amount of 25 to 400 parts by mass per 100 parts by mass of the sum of components (A), (B) and (C).

A curable hotmelt film of the present invention is prepared by partial proceeding of hydrosilylation reaction of the above composition.

### Advantageous Effects of Invention

The phosphor-containing curable silicone composition of the present invention can be cured to form a hotmelt film having residual hydrosilylation reactivity for full cure by partial completion of hydrosilylation reaction. The curable hotmelt film of the present invention can be cured to a product having excellent permanent adhesion to the semiconductor device.

### MODE FOR THE INVENTION

The phosphor-containing curable silicone composition of the present invention comprises: (A) an alkenyl group-functional organopolysiloxane, (B) an organohydrogenpolysiloxane having two hydrogen atoms each directly bonded to silicon atoms in a molecule, (C) a hydrosilylation catalyst, and (D) a phosphor, wherein component (A) consists of components (A-1), (A-2), and (A-3).

Component (A-1) is an organopolysiloxane resin serving as a base component of component (A). Component (A-1) is represented by the following average unit formula (1):

(R¹R²₂SiO_{1/2})ₐ(R²₃SiO_{1/2})_{b}(R²₂SiO_{2/2})_{c}(R²SiO_{3/2})_{d}(SiO_{4/2})ₑ(R³O_{1/2})_{f} (1)

In the formula, R¹ is an alkenyl group having 2 to 10 carbon atoms; R² is an alkyl group having 1 to 10 carbon atoms, a cycloalkyl group having 3 to 10 carbon atoms, or an aryl group having 6 to 12 carbon atoms, with the proviso that at least 40 mol % of R² are aryl groups; R³ is hydrogen atom or an alkyl group having 1 to 10 carbon atoms; “a” is a number of 0.1 to 0.4, “b” is a number of 0 to 0.3, “c” is a number of 0 to 0.3, “d” is a number of 0.4 to 0.9, “e” is a number of 0 to 0.2, “f” is a number of 0 to 0.05, with the proviso that the sum of “a” to “e” is 1.

The alkenyl groups represented by R¹ are preferably those of 2 to 6 carbon atoms, more preferably those of 2 to 3 carbon atoms, examples of which include vinyl, allyl, propenyl, butenyl, pentenyl, hexenyl, and cyclohexenyl groups. The alkyl groups represented by R² are preferably those of 1 to 6 carbon atoms, more preferably methyl groups, examples of which include methyl, ethyl, propyl, isopropyl, butyl, isobutyl, and hexyl groups. The cycloalkyl groups represented by R² are preferably those of 5 to 10 carbon atoms, more preferably cyclohexyl group. The aryl groups represented by R² are preferably those of 6 to 10 carbon atoms, more preferably phenyl groups, examples of which include phenyl, toryl, xylyl, 1-naphthyl, and 2-naphthyl groups. The alkyl groups represented by R³ are preferably those of 1 to 6 carbon atoms, more preferably methyl or ethyl groups, examples of which include methyl, ethyl, propyl, isopropyl, butyl, isobutyl, and hexyl groups. The subscripts “a”, “b”, “c”, “d”, “e”, and “f” are preferably numbers of 0.2 to 0.3, 0 to 0.15, 0 to 0.15, 0.6 to 0.8, 0 to 0.1, and 0 to 0.03, respectively.

The amount of component (A-1) in component (A) is 78 to 99% by mass, preferably 80 to 97% by mass. By using component (A-1) in an amount of 78% by mass or more, it is possible to enhance the adhesive strength of a film produced by the composition according to the present invention. Further, by using component (A-1) in component (A) in an amount of 99% by mass or less, it is possible to improve the peel-off strength of the film.

Component (A-2) is another organopolysiloxane resin serving as an additive for material toughening and adhesion improvement. Component (A-2) is represented by the following average unit formula (2):

(R⁵₃SiO_{1/2})_{g}(R⁴R⁵SiO_{2/2})ₕ(R⁵₂SiO_{2/2})ᵢ(R⁵SiO_{3/2})ⱼ(SiO_{4/2})ₖ(R⁶O_{1/2})ₗ (2)

In the formula, R⁴ is an alkenyl group having 2 to 10 carbon atoms; R⁵ is an alkyl group having 1 to 10 carbon atoms, a cycloalkyl group having 3 to 10 carbon atoms, or an aryl group having 6 to 12 carbon atoms, with the proviso that at least 40 mol % of R⁵ are aryl groups; R⁶ is hydrogen atom or an alkyl group having 1 to 10 carbon atoms; “g” is a number of 0 to 0.2, “h” is a number of 0.05 to 0.3, “i” is a number of 0 to 0.3, “j” is a number of 0.4 to 0.9, “k” is a number of 0 to 0.2, “l” is a number of 0 to 0.05, with the proviso that the sum of “g” to “k” is 1.

The alkenyl groups represented by R⁴ are preferably those of 2 to 6 carbon atoms, more preferably those of 2 to 3 carbon atoms, examples of which are as exemplified above for R¹. The alkyl groups represented by R⁵ are preferably those of 1 to 6 carbon atoms, more preferably methyl group, examples of which are as exemplified above for R². The cycloalkyl groups represented by R⁵ are preferably those of 5 to 10 carbon atoms, more preferably cyclohexyl group. The aryl groups represented by R⁵ are preferably those of 6 to 10 carbon atoms, more preferably phenyl groups, examples of which are as exemplified above for R². The alkyl groups represented by R⁶ are preferably those of 1 to 6 carbon atoms, more preferably methyl or ethyl groups, examples of which are as exemplified above for R³. The subscripts “g”, “h”, “i”, “j”, “k”, and “l” are preferably numbers of 0 to 0.2, 0.05 to 0.2, 0 to 0.2, 0.6 to 0.8, 0 to 0.1, and 0 to 0.03, respectively.

The amount of component (A-2) in component (A) is 1 to 7% by mass, preferably 1 to 5% by mass. By using component (A-2) in an amount of 1% by mass or more, a film produced by the composition according to the present invention can be tackfree to improve its peel-off strength. Further, by using component (A-2) in an amount of 7% by mass or less, it is possible to enhance the adhesive strength of the film without any cracking.

Component (A-3) is an organopolysiloxane serving as an optional additive for material modulus control. Component (A-3) is represented by the following average formula (3):

R⁷₃SiO—(R⁷₂SiO)ₙ—SiR⁷₃ (3)

In the formula, R⁷ is an alkenyl group having 2 to 10 carbon atoms, an alkyl group having 1 to 10 carbon atoms, a cycloalkyl group having 3 to 10 carbon atoms, or an aryl group having 6 to 12 carbon atoms, with the proviso that at least two R⁷ in a molecule are alkenyl groups, at least 30 mol % of R⁷ are aryl groups; and “n” is an integer of 4 to 100.

The alkenyl groups represented by R⁷ are preferably those of 2 to 6 carbon atoms, more preferably those of 2 to 3 carbon atoms, examples of which are as exemplified above for R¹. The alkyl groups represented by R⁷ are preferably those of 1 to 6 carbon atoms, more preferably methyl groups, examples of which are as exemplified above for R². The cycloalkyl groups represented by R⁷ are preferably those of 5 to 10 carbon atoms, more preferably cyclohexyl group. The aryl groups represented by R⁷ are preferably those of 6 to 10 carbon atoms, more preferably phenyl groups, examples of which are as exemplified above for R². The subscript “n” is preferably an integer of 4 to 50.

The amount of component (A-3) in component (A) is 0 to 15% by mass, preferably 2 to 10% by mass. By using component (A-3) in an amount of 15% by mass or less, it is possible to easily peel off a film produced by the composition according to the present invention while preventing the deformation of the film, which occurs due to the stickiness of the film, and it is possible to increase the hardness of the cured material.

Component (B) is an organohydrogenpolysiloxane having two hydrogen atoms each directly bonded to silicon atoms in a molecule, which serves as a crosslinking agent for causing the composition to cure, by inducing a hydrosilylation reaction with the alkenyl group-functional organopolysiloxane (A). The organic groups in this component are preferably alkyl, cycloalkyl, and aryl groups, more preferably methyl and phenyl groups. Examples of this component are given below. In the formula, “x” is an integer of 0 to 50, “y” is an integer of 1 to 20, “z” is an integer of 1 to 10, “p” is an integer of 0 to 10, and “q” is an integer of 0 to 10.

HMe₂SiO(Me₂SiO)SiMe₂H

HMe₂SiO(MePhSiO)_{y}SiMe₂H

HMe₂SiO(Ph₂SiO)_{z}SiMe₂H

HMePhSiO(Ph₂SiO)ₚSiMePhH

HPh₂SiO(Ph₂SiO)_{q}SiPh₂H

The amount of component (B) in the composition is an amount that provides 0.5 to 10, and preferably 0.7 to 2 silicon atom-bonded hydrogen atoms per one alkenyl group in component (A). By using component (B) in an amount that provides 0.5 silicon atom-bonded hydrogen atoms or more per one alkenyl group in component (A), the curing reaction proceeds to achieve a silicone cured product. Further, by using component (B) in an amount that provides 10 silicon atom-bonded hydrogen atoms or less per one alkenyl group in component (A), it is possible to prevent changes in the properties of the cured product over time, which is caused by the remains of a large quantity of unreacted SiH groups within the cured product.

Component (C) is a hydrosilylation catalyst, which is used for accelerating the hydrosilylation between silicon-bonded hydrogen atoms of component (B) and alkenyl groups contained in component (A). Component (C) may comprise a platinum-based catalyst, rhodium-based catalyst, or a palladium-based catalyst. The platinum-based catalyst is preferable since it significantly accelerates curing of the composition. The platinum-based catalyst can be exemplified by a platinum-alkenylsiloxane complex, a platinum-olefin complex, or a platinum-carbonyl complex, of which the platinum-alkenylsiloxane complex is preferable. Such an alkenylsiloxane can be exemplified by the 1,3-divinyl-1,1,3,3-tetramethyl disiloxane; 1,3,5,7-tetramethyl-1,3,5,7-tetravinyl cyclotetrasiloxane; substituted alkenylsiloxane which are the aforementioned alkenyl-siloxanes having a part of the methyl groups substituted with ethyl, phenyl groups; or substituted alkenylsiloxane which are the aforementioned alkenylsiloxanes having a part of the vinyl groups substituted with aryl, hexenyl, or similar groups. From the viewpoint of better stability of the platinum-alkenylsiloxane complexes, the use of the 1,3-divinyl-1,1,3,3-tetramethyl disiloxane is preferable. For further improvement of stability, the aforementioned alkenylsiloxane complexes can be combined with 1,3-divinyl-1,1,3,3-tetramethyl disiloxane, 1,3-diallyl-1,1,3,3-tetramethyl disiloxane, 1,3-divinyl-1,1,3,3-tetraphenyl disiloxane, 1,3,5,7-tetramethyl-1,3,5,7-tetravinyl cyclotetrasiloxane, or similar alkenylsiloxanes, dimethylsiloxane oligomers, or other organosiloxane oligomers. Most preferable are alkenylsiloxanes.

Component (C) is added in an amount sufficient for curing the composition. More specifically, in terms of mass units, this component is added in an amount of 0.01 to 500 ppm, preferably 0.01 to 100 ppm, and most preferably, 0.01 to 50 ppm of the metal atoms of this component per mass of the composition. By adding component (C) in an amount of the recommended lower limit or more, the composition can be cured to a sufficient degree. Further, by adding component (C) in an amount of the recommended upper limit or less, it is possible to prevent coloring of a cured product of the composition.

Component (D) is a phosphor, which is comprised for wavelength conversion of the film produced by the composition according to the present invention. The phosphor is not particularly limited and may include any known in the art. In one embodiment, the phosphor is made from a host material and an activator, such as copper-activated zinc sulfide and silver-activated zinc sulfide. Suitable but non-limiting host materials include oxides, nitrides and oxynitrides, sulfides, selenides, halides or silicates of zinc, cadmium, manganese, aluminum, silicon, or various rare earth metals. Additional suitable phosphors include, but are not limited to, Zn₂SiO₄:Mn (Willemite); ZnS:Ag+(Zn,Cd)S:Ag; ZnS:Ag+ZnS:Cu+Y₂O₂S:Eu; ZnO:Zn; KCl; ZnS:Ag,Cl or ZnS:Zn; (KF,MgF₂):Mn; (Zn,Cd)S:Ag or (Zn,Cd)S:Cu; Y₂O₂S:Eu+Fe₂O₃, ZnS:Cu,Al; ZnS:Ag+Co-on-Al₂O₃; (KF,MgF₂):Mn; (Zn,Cd)S:Cu,Cl; ZnS:Cu or ZnS:Cu,Ag; MgF₂:Mn; (Zn,Mg)F₂:Mn; Zn₂SiO₄:Mn,As; ZnS:Ag+(Zn,Cd)S:Cu; Gd₂O₂S:Tb; Y₂O₂S:Tb; Y₃Al₅O₁₂:Ce; Y₂SiO₅:Ce; Y₃Al₅O₁₂:Tb; ZnS:Ag,Al; ZnS:Ag; ZnS:Cu,Al or ZnS:Cu,Au,Al; (Zn,Cd)S:Cu,Cl+(Zn,Cd)S:Ag,Cl; Y₂SiO₅:Tb; Y₂OS:Tb; Y₃(Al,Ga)₅O₁₂:Ce; Y₃(Al,Ga)₅O₁₂:Tb; InBO₃:Tb; InBO₃:Eu; InBO₃:Tb+InBO₃:Eu; InBO₃:Tb+InBO₃:Eu+ZnS:Ag; (Ba,Eu)Mg₂Al₁₆O₂₇; (Ce,Tb)MgAl₁₁O₁₉; BaMgAl₁₀O₁₇:Eu,Mn; BaMg₂Al₁₆O₂₇:Eu(II); BaMgAl₁₀O₁₇:Eu,Mn; BaMg₂Al₁₆O₂₇:Eu(II),Mn(II); Ce_{0.67}Tb_{0.33}MgAl₁₁O₁₉:Ce,Tb; Zn₂SiO₄:Mn,Sb₂O₃; CaSiO₃:Pb,Mn; CaWO₄ (Scheelite); CaWO₄:Pb; MgWO₄; (Sr,Eu,Ba,Ca)₅(PO₄)₃Cl; Sr₅Cl(PO₄)₃:Eu(II); (Ca,Sr,Ba)₃(PO₄)₂Cl₂:Eu; (Sr,Ca,Ba)₁₀(PO₄)₆Cl₂:Eu; Sr₂P₂O₇:Sn(II); Sr₆P₅BO₂₀:Eu; Ca₅F(PO₄)₃:Sb; (Ba,Ti)₂P₂O₇:Ti; 3Sr₃(PO₄)₂.SrF₂:Sb,Mn; Sr₅F(PO₄)₃:Sb,Mn; Sr₅F(PO₄)₃:Sb,Mn; LaPO₄:Ce,Tb; (La,Ce,Tb)PO₄; (La,Ce,Tb)PO₄:Ce,Tb; Ca₃(PO₄)₂.CaF₂:Ce,Mn; (Ca,Zn,Mg)₃(PO₄)₂:Sn; (Zn,Sr)₃(PO₄)₂:Mn; (Sr,Mg)₃(PO₄)₂:Sn; (Sr,Mg)₃(PO₄)₂:Sn(II); Ca₅F(PO₄)₃:Sb,Mn; Ca₅(F,Cl)(PO₄)₃:Sb,Mn; (Y,Eu)₂O₃; Y₂O₃:Eu(III); Mg₄(F)GeO₆:Mn; Mg₄(F)(Ge,Sn)O₆:Mn; Y(P,V)O₄:Eu; YVO₄:Eu; Y₂O₂S:Eu; 3.5 MgO-0.5 MgF₂GeO₂:Mn; Mg₅As₂O₁₁:Mn; SrAl₂O₇:Pb; LaMgAl₁₁O₁₉:Ce; LaPO₄:Ce; SrAl₁₂O₁₉:Ce; BaSi₂O₅:Pb; SrFB₂O₃:Eu(II); SrB₄O₇:Eu; Sr₂MgSi₂O₇:Pb; MgGa₂O₄:Mn(II); Gd₂O₂S:Tb; Gd₂O₂S:Eu; Gd₂O₂S:Pr; Gd₂O₂S:Pr,Ce,F; Y₂O₂S:Tb; Y₂O₂S:Eu; Y₂O₂S:Pr; Zn(0.5)Cd(0.4)S:Ag; Zn(0.4)Cd(0.6)S:Ag; CdWO₄; CaWO₄; MgWO₄; Y₂SiO₅:Ce;YAlO₃:Ce; Y₃Al₅O₁₂:Ce; Y₃(Al,Ga)₅O₁₂:Ce; CdS:In; ZnO:Ga; ZnO:Zn; (Zn,Cd)S:Cu,Al; ZnS:Cu,Al,Au; ZnCdS:Ag,Cu; ZnS:Ag; anthracene, EJ-212, Zn₂SiO₄:Mn; ZnS:Cu; NaI:Tl; CsI:Tl; LiF/ZnS:Ag; LiF/ZnSCu,Al,Au, and combinations thereof.

Component (D) is added in an amount of 25 to 400 parts by mass per 100 parts by mass of the sum of components (A), (B) and (C). By adding component (D) in an amount of 25 parts by mass or more per 100 parts by mass of the sum of components (A), (B), and (C); it is possible to obtain the wavelength conversion effect of the film. Further, by adding component (D) in an amount of 400 parts by mass or less, it is possible to prevent the impairment of the mechanical strength of a cured body of the composition.

If necessary, the composition may incorporate arbitrary components, such as 2-methyl-3-butyn-2-ol, 3,5-dimethyl-1-hexyn-3-ol, 2-phenyl-3-butyn-2-ol, or similar alkyn alcohols; 3-methyl-3-penten-1-yne, 3,5-dimethyl-3-hexen-1-yne, or a similar enyne-based compound; 1,3,5,7-tetramethyl-1,3,5,7-tetravinyl cyclotetrasiloxane, 1,3,5,7-tetramethyl-1,3,5,7-tetrahexenyl cyclotetrasiloxane, benzotriazole or similar reaction inhibitors. Although there are no special restrictions with regard to the amounts in which the aforementioned reaction inhibitors can be used, it is recommended to add the reaction inhibitors in an amount of 0.0001 to 5 parts by mass per 100 parts by mass of the sum of components (A) to (D).

If necessary, an adhesion-imparting agent can be added to the composition of the invention for improving its adhesive properties. Such an agent may comprise an organic silicon compound which is different from aforementioned components (A) and (B) and which contains at least one silicon-bonded alkoxy group per molecule. This alkoxy group can be represented by a methoxy, ethoxy, propoxy, and a butoxy group. A methoxy group is the most preferable. Groups other than the aforementioned silicon-bonded alkoxy groups of the organic silicon compound also can be used. Examples of such other groups are the following: substituted or unsubstituted monovalent hydrocarbon groups such as the aforementioned alkyl groups, alkenyl groups, aryl groups, aralkyl groups; 3-glycidoxypropyl groups, 4-glycidoxybutyl groups, or similar glycidoxyalkyl groups; 2-(3,4-epoxycyclohexyl) ethyl groups, 3-(3,4-epoxycyclohexyl) propyl groups, or similar epoxycyclohexyl groups; 4-oxiranylbutyl groups, 8-oxiranyloctyl groups, or similar oxiranylalkyl groups, or other epoxy-containing monovalent organic groups; 3-methacryloxypropyl groups, or similar acryl-containing monovalent organic groups; and hydrogen atoms. At least one of these groups can be contained in one molecule. The most preferable are epoxy-containing and acryl-containing monovalent organic groups. It is recommended that the aforementioned organic silicon compounds contain groups to react with components (A) and (B), in particular such groups as silicon-bonded alkenyl groups and silicon-bonded hydrogen atoms. For better adhesion to various materials, it is preferable to use the aforementioned organic silicon compounds that have at least one epoxy-containing monovalent group per molecule. Examples of such compounds are organosilane compounds and organosiloxane oligomers. The aforementioned organosilane oligomers may have a straight-chain, partially-branched straight-chain, branched-chain, cyclic, and net-like molecular structure. The straight-chain, branched-chain, and net-like structures are preferable. The following are examples of the aforementioned organic silicon compounds: 3-glycidoxypropyltrimethoxysilane, 2-(3,4-epoxycyclohexyl) ethyltrimethoxysilane, 3-methacryloxypropyltrimethoxysilane, or similar silane compounds; a siloxane compound having in one molecule at least one silicon-bonded alkenyl group, at least one silicon-bonded hydrogen atom, or at least one silicon-bonded alkoxy group; a silane compound having at least one silicon-bonded alkoxy group; a mixture of a silane or a siloxane compound having at least one silicon-bonded alkoxy group with a siloxane compound having in one molecule at least one silicon-bonded hydroxyl group and at least one silicon-bonded alkenyl group; a siloxane compound represented by the following formula:

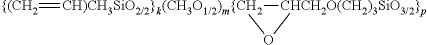

where k, m, and p are positive numbers; and a siloxane compound represented by the following formula:

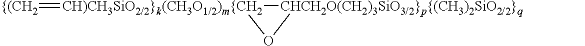

where k, m, p, and q are positive numbers. There are no special restrictions with regard to the content of the adhesion-imparting agent in the composition, it is recommended to use it in the amount of 0.01 to 10 parts by mass for each 100 parts by mass of the sum of components (A) and (B).

Within the limits not contradictory to the object of the invention, the aforementioned arbitrary components may also include silica, glass, alumina, zinc oxide, or other inorganic fillers; a powdered polymethacrylate resin, or other fine organic resin powders; as well as heat-resistance agents, dyes, pigments, flame retardants, solvents, etc.

Although there are no restrictions with regard to a viscosity of the composition at 25° C., it is recommended that the viscosity of the composition be in the range of 100 to 1,000,000 mPa·s, preferably 500 to 50,000 mPa·s. If the composition has a viscosity of the recommended lower limit or more, the impairment of the mechanical strength of a cured body of the composition can be prevented. Further, if the composition has a viscosity of the recommended upper limit or less, the impairment of the handleability and workability of the composition can be prevented.

In a visible light (589 nm), the present composition has an index of refraction (at 25° C.) which is equal to or greater than 1.5. It is recommended that the transmittance (at 25° C.) of light through a cured product obtained by curing the composition be equal to or greater than 80%. If the index of refraction of the composition is below 1.5, and the light transmittance through the cured product is below 80%, it will be impossible to impart sufficient reliability to a semiconductor device having a semiconductor part coated with a cured body of the composition. The index of refraction can be measured, e.g., with the use of an Abbe refractometer. By changing the wavelength of the light source used in the Abbe refractometer, it is possible to measure the index of refraction at any wavelength. Furthermore, the index of refraction can be also determined with the use of a spectrophotometer by measuring a cured body of the composition having an optical path of 1.0 mm.

The composition of the invention is cured at room temperature or by heating. However, for acceleration of the curing process, heating is recommended. The heating temperature is in the range of 50 to 200° C. The composition of the invention may be used as an adhesive, potting agent, protective agent, coating agent, or underfiller agent for parts of electrical and electronic devices. In particular, since the composition has high light-transmittance, it is suitable for use as an adhesive, potting agent, protective agent, or underfiller agent for semiconductor parts of optical devices.

The curable hotmelt film of the invention will now be described in more details. The film thickness typically within the range from 1 to 500 um, preferably from 10 to 300 um. The film is preferably less tacky at room temperature for the film fabrication processes such as dicing, pick-up, and releasing after transfer. The film needs to be molten prior to cure to achieve good adhesion against the substrate and good wetting on the substrate surface.

The curable hotmelt film of the present invention is prepared by half curing of the composition. Extent of the half curing is determined by a conversion of the hydrosilylation reaction. The reaction conversion is identified conveniently by a DSC measurement. The reaction conversion for the half curing is preferably 80 to 90%. The film fabrication is conducted several ways which include compression molding, casting molding, and injection molding of the above curable composition, and slot coating and bar coating of the solution of the above composition diluted with a solvent. In order to obtain good hotmelt properties, the temperature and process time need to be selected appropriately.

### EXAMPLES

The phosphor-containing curable silicone composition and curable hotmelt film of the present invention will be further described in more detail with reference to Practical and Comparative examples. In the formulae, Me, Ph, Vi, and Ep corresponds to methyl groups, phenyl groups, vinyl groups, and 3-glycidoxypropyl groups, respectively.

### Example 1

A curable silicone composition was prepared by mixing: 68.5 parts by mass of an organopolysiloxane resin represented by the following average unit formula:

(ViMe₂SiO_{1/2})_{0.15}(PhSiO_{3/2})_{0.85}(HO_{1/2})_{0.002},

3.1 parts by mass of an organopolysiloxane resin represented by the following average unit formula:

(MeVisiO_{2/2})_{0.10}(Me₂SiO_{2/2})_{0.15}(PhSiO_{3/2})_{0.75}(HO_{1/2})_{0.003},

3.2 parts by mass of an organopolysiloxane represented by the following average formula:

ViMe₂SiO—(MePhSiO)₁₅—SiMe₂Vi,

23.10 parts by mass of an organohydrogenpolysiloxane represented by the following formula:

HMe₂SiO(Ph₂SiO)SiMe₂H,

0.01 parts by mass of platinum-1,1,3,3-tetramethyl-1,3-divinyldisiloxane complex in excess the disiloxane (platinum content is 4.5% by mass), 0.06 parts by mass of 1-ethynylcyclohexan-1-ol, and 2.0 parts by mass of epoxy-functional organopolysiloxane resin represented by the following average unit formula:

(ViMe₂SiO_{1/2})_{0.20}(MeEpSiO_{2/2})_{0.20}(PhSiO_{3/2})_{0.60}.

To 30 parts by mass of the obtained composition were added 70 parts by mass of a YAG phosphor (Intematix NYAG4454) and 20 parts by mass of mesitylene, and the mixture was mixed by a Dental mixer until the uniform mixture was obtained. The solution was coated in 100 μm in thickness on a PET film followed by heating at 100° C. for 15 minutes. The reaction conversion determined by DSC measurement was 82%. The obtained film was peeled off from the PET film and placed onto a silicon wafer followed by heating at 150° C. for 30 min. The film supported on the PET film was tackfree and was cut off to smaller piece by knife without any cracking and deformation. The cross-cut test result showed that 90% of attached area of the film was adhered well to the surface of silicon wafer. Durometer D hardness of fully cured materials separately prepared was 58.

### Example 2

A curable silicone composition was prepared by mixing: 69.3 parts by mass of an organopolysiloxane resin represented by the following average unit formula:

(ViMe₂SiO_{1/2})_{0.15}(PhSiO_{3/2})_{0.85}(HO_{1/2})_{0.002},

1.1 parts by mass of an organopolysiloxane resin represented by the following average unit formula:

(MeViSiO_{2/2})_{0.10}(Me₂SiO_{2/2})_{0.15}(PhSiO_{3/2})_{0.75}(HO_{1/2})_{0.003},

4.0 parts by mass of an organopolysiloxane represented by the following average formula:

ViMe₂SiO—(MePhSiO)₁₅—SiMe₂Vi,

23.0 parts by mass of an organohydrogenpolysiloxane represented by the following formula:

HMe₂SiO(Ph₂SiO)SiMe₂H,

0.01 parts by mass of platinum-1,1,3,3-tetramethyl-1,3-divinyldisiloxane complex in excess the disiloxane (platinum content is 4.5% by mass), 0.06 parts by mass of 1-ethynylcyclohexan-1-ol, and 2.5 parts by mass of epoxy-functional organopolysiloxane resin represented by the following average unit formula:

(ViMe₂SiO_{1/2})_{0.20}(MeEpSiO_{2/2})_{0.20}(PhSiO_{3/2})_{0.60}.

To 30 parts by mass of the obtained composition were added 70 parts by mass of a YAG phosphor (Intematix NYAG4454) and 20 parts by mass of mesitylene, and the mixture was mixed by a Dental mixer until the uniform mixture was obtained. The solution was coated in 100 μm in thickness on a PET film followed by heating at 100° C. for 15 minutes. The reaction conversion determined by DSC measurement was 86%. The obtained film was peeled off from the PET film and placed onto a silicon wafer followed by heating at 150° C. for 30 min. The film supported on the PET film was tackfree solid and was cut off to smaller piece by knife without any cracking and deformation. The cross-cut test result showed that 100% of attached area of the film was adhered well to the surface of silicon wafer. Durometer D hardness of fully cured materials separately prepared was 56.

### Example 3

A curable silicone composition was prepared by mixing: 66.5 parts by mass of an organopolysiloxane resin represented by the following average unit formula:

(ViMe₂SiO_{1/2})_{0.15}(PhSiO_{3/2})_{0.85}(HO_{1/2})_{0.002},

3.0 parts by mass of an organopolysiloxane resin represented by the following average unit formula:

(MeViSiO_{2/2})_{0.10}(Me₂SiO_{2/2})_{0.15}(PhSiO_{3/2})_{0.75}(HO_{1/2})_{0.003},

6.1 parts by mass of an organopolysiloxane represented by the following average formula:

ViMe₂SiO—(MePhSiO)₁₅—SiMe₂Vi,

22.2 parts by mass of an organohydrogenpolysiloxane represented by the following formula:

HMe₂SiO(Ph₂SiO)SiMe₂H,

0.01 parts by mass of platinum-1,1,3,3-tetramethyl-1,3-divinyldisiloxane complex in excess the disiloxane (platinum content is 4.5% by mass), 0.06 parts by mass of 1-ethynylcyclohexan-1-ol, and 2.0 parts by mass of epoxy-functional organopolysiloxane resin represented by the following average unit formula:

(ViMe₂SiO_{1/2})_{0.20}(MeEpSiO_{2/2})_{0.20}(PhSiO_{3/2})_{0.60}.

To 30 parts by mass of the obtained composition were added 70 parts by mass of a YAG phosphor (Intematix NYAG4454) and 20 parts by mass of mesitylene, and the mixture was mixed by a Dental mixer until the uniform mixture was obtained. The solution was coated in 100 μm in thickness on a PET film followed by heating at 100° C. for 15 minutes. The reaction conversion determined by DSC measurement was 85%. The obtained film was peeled off from the PET film and placed onto a silicon wafer followed by heating at 150° C. for 30 min. The film supported on the PET film was tackfree solid and was cut off to smaller piece by knife without any cracking and deformation. The cross-cut test result showed that 100% of attached area of the film was adhered well to the surface of silicon wafer. Durometer D hardness of fully cured materials separately prepared was 55.

### Comparative Example 1

A curable silicone composition was prepared by mixing: 66.3 parts by mass of an organopolysiloxane resin represented by the following average unit formula:

(ViMe₂SiO_{1/2})_{0.15}(PhSiO_{3/2})_{0.85}(HO_{1/2})_{0.002},

8.8 parts by mass of an organopolysiloxane represented by the following average formula:

ViMe₂SiO—(MePhSiO)₁₅—SiMe₂Vi,

24.3 parts by mass of an organohydrogenpolysiloxane represented by the following formula:

HMe₂SiO(Ph₂SiO)SiMe₂H,

0.01 parts by mass of platinum-1,1,3,3-tetramethyl-1,3-divinyldisiloxane complex in excess the disiloxane (platinum content is 4.5% by mass), and 0.06 parts by mass of 1-ethynylcyclohexan-1-ol.

To 30 parts by mass of the obtained composition were added 70 parts by mass of a YAG phosphor (Intematix NYAG4454) and 20 parts by mass of mesitylene, and the mixture was mixed by a Dental mixer until the uniform mixture was obtained. The solution was coated in 100 μm in thickness on a PET film followed by heating at 100° C. for 15 minutes. The reaction conversion determined by DSC measurement was 85%. The obtained film was peeled off from the PET film and placed onto a silicon wafer followed by heating at 150° C. for 30 min. The film supported on the PET film was sticky and cutting off to smaller piece by knife caused deformation of the film and film stick to the knife The cross-cut test result showed that 100% of attached area of the film was adhered well to the surface of silicon wafer. Durometer D hardness of fully cured materials separately prepared was 45.

### Comparative Example 2

A curable silicone composition was prepared by mixing: 67.6 parts by mass of an organopolysiloxane resin represented by the following average unit formula:

(ViMe₂SiO_{1/2})_{0.15}(PhSiO_{3/2})_{0.85}(HO_{1/2})_{0.002},

5.5 parts by mass of an organopolysiloxane resin represented by the following average unit formula:

(MeViSiO_{2/2})_{0.10}(Me₂SiO_{2/2})_{0.15}(PhSiO_{3/2})_{0.75}(HO_{1/2})_{0.003},

3.2 parts by mass of an organopolysiloxane represented by the average formula:

ViMe₂SiO—(MePhSiO)₁₅—SiMe₂Vi,

24.3 parts by mass of an organohydrogenpolysiloxane represented by the following formula:

HMe₂SiO(Ph₂SiO)SiMe₂H,

0.01 parts by mass of platinum-1,1,3,3-tetramethyl-1,3-divinyldisiloxane complex in excess the disiloxane (platinum content is 4.5% by mass), and 0.06 parts by mass of 1-ethynylcyclohexan-1-ol.

To 30 parts by mass of the obtained composition were added 70 parts by mass of a YAG phosphor (Intematix NYAG4454) and 20 parts by mass of mesitylene, and the mixture was mixed by a Dental mixer until the uniform mixture was obtained. The solution was coated in 100 μm in thickness on a PET film followed by heating at 100° C. for 15 minutes. The reaction conversion determined by DSC measurement was 86%. The obtained film was peeled off from the PET film and placed onto a silicon wafer followed by heating at 150° C. for 30 min. The film supported on the PET film was tackfree but cutting off to smaller piece by knife caused cracking of the film. The cross-cut test result showed that as low as 50% of attached area of the film was adhered well to the surface of silicon wafer. Durometer D hardness of fully cured materials separately prepared was 62.

### Comparative Example 3

A curable silicone composition was prepared by mixing: 61.5 parts by mass of an organopolysiloxane resin represented by the following average unit formula:

(ViMe₂SiO_{1/2})_{0.15}(PhSiO_{3/2})_{0.85}(HO_{1/2})_{0.002},

2.6 parts by mass of an organopolysiloxane resin represented by the following average unit formula:

(MeViSiO_{2/2})_{0.10}(Me₂SiO_{2/2})_{0.15}(PhSiO_{3/2})_{0.75}(HO_{1/2})_{0.003},

13.1 parts by mass of an organopolysiloxane represented by the following average formula:

ViMe₂SiO—(MePhSiO)₁₅—SiMe₂Vi,

20.7 parts by mass of an organohydrogenpolysiloxane represented by the following formula:

HMe₂SiO(Ph₂SiO)SiMe₂H,

0.01 parts by mass of platinum-1,1,3,3-tetramethyl-1,3-divinyldisiloxane complex in excess the disiloxane (platinum content is 4.5% by mass), 0.06 parts by mass of 1-ethynylcyclohexan-1-ol, and 2.0 parts by mass of epoxy-functional organopolysiloxane resin represented by the following average unit formula:

(ViMe₂SiO_{1/2})_{0.20}(MeEpSiO_{2/2})_{0.20}(PhSiO_{3/2})_{0.60}.

To 30 parts by mass of the obtained composition were added 70 parts by mass of a YAG phosphor (Intematix NYAG4454) and 20 parts by mass of mesitylene, and the mixture was mixed by a Dental mixer until the uniform mixture was obtained. The solution was coated in 100 μm in thickness on a PET film followed by heating at 100° C. for 15 minutes. The reaction conversion determined by DSC measurement was 82%. The obtained film was peeled off from the PET film and placed onto a silicon wafer followed by heating at 150° C. for 30 min. The film supported on the PET film was sticky and cutting off to smaller piece by knife caused deformation of the film and film stick to the knife The cross-cut test result showed that 100% of attached area of the film was adhered well to the surface of silicon wafer. Durometer D hardness of fully cured materials separately prepared was 44.

### Comparative Example 4

A curable silicone composition was prepared by mixing: 69.3 parts by mass of an organopolysiloxane resin represented by the following average unit formula:

(ViMe₂SiO_{1/2})_{0.15}(PhSiO_{3/2})_{0.85}(HO_{1/2})_{0.002},

1.1 parts by mass of an organopolysiloxane resin represented by the following average unit formula:

(MeViSO_{2/2})_{0.10}(Me₂SiO_{2/2})_{0.15}(PhSiO_{3/2})_{0.75}(HO_{1/2})_{0.003},

4.0 parts by mass of an organopolysiloxane represented by the following average formula:

ViMe₂SiO—(MePhSiO)₁₅—SiMe₂Vi,

17.4 parts by mass of an organohydrogenpolysiloxane represented by the following formula:

HMe₂SiO(Ph₂SiO)SiMe₂H,

5.6 parts by mass of an organohydrogenpolysiloxane resin represented by the following average unit formula:

(Me₂HSiO_{1/2})_{0.60}(PhSiO_{3/2})_{0.40}(HO_{1/2})_{0.002},

0.01 parts by mass of platinum-1,1,3,3-tetramethyl-1,3-divinyldisiloxane complex in excess the disiloxane (platinum content is 4.5% by mass), 0.06 parts by mass of 1-ethynylcyclohexan-1-ol, and 2.5 parts by mass of epoxy-functional organopolysiloxane resin represented by the following average unit formula:

(ViMe₂SiO_{1/2})_{0.20}(MeEpSiO_{2/2})_{0.20}(PhSiO_{3/2})_{0.60}.

To 30 parts by mass of the obtained composition were added 70 parts by mass of a YAG phosphor (Intematix NYAG4454) and 20 parts by mass of mesitylene, and the mixture was mixed by a Dental mixer until the uniform mixture was obtained. The solution was coated in 100 μm in thickness on a PET film followed by heating at 100° C. for 15 minutes. The reaction conversion determined by DSC measurement was 85%. The obtained film was peeled off from the PET film and placed onto a silicon wafer followed by heating at 150° C. for 30 min. The film supported on the PET film was tackfree but cutting off to smaller piece by knife caused severe cracking. The cross-cut test result showed that as low as 30% of attached area of the film was adhered well to the surface of silicon wafer. Durometer D hardness of fully cured materials separately prepared was 76.

### INDUSTRIAL APPLICABILITY

A phosphor-containing curable silicone composition of the present invention which can form a curable hotmelt film used for light-emitting semiconductor device is provided. The composition containing the phosphor can form a tack free film at room temperature by half cure and the film is easy to fabricate the desired forms. The fabricated film is easy to pick up them from the support substrate and transferred onto a light emitting semiconductor device at room temperature. The laminated film is molten followed by cured by heating to give excellent permanent adhesion to the device surface.

1. A phosphor-containing curable silicone composition comprising:
(A) an alkenyl group-functional organopolysiloxane comprising 78 to 99% by mass of (A-1) an organopolysiloxane resin represented by the following average unit formula (1):
(R¹R²₂SiO_{1/2})ₐ(R²₃SiO_{1/2})_{b}(R²₂SiO_{2/2})_{c}(R²SiO_{3/2})_{d}(SiO_{4/2})ₑ(R³O_{1/2})_{f} (1)
wherein R¹ is an alkenyl group having 2 to 10 carbon atoms; R² is an alkyl group having 1 to 10 carbon atoms, a cycloalkyl group having 3 to 10 carbon atoms, or an aryl group having 6 to 12 carbon atoms, with the proviso that at least 40 mol % of R² are aryl groups; R³ is a hydrogen atom or an alkyl group having 1 to 10 carbon atoms; “a” is a number of 0.1 to 0.4, “b” is a number of 0 to 0.3, “c” is a number of 0 to 0.3, “d” is a number of 0.4 to 0.9, “e” is a number of 0 to 0.2, “f” is a number of 0 to 0.05, with the proviso that the sum of “a” to “e” is 1;
1 to 7% by mass of (A-2) an organopolysiloxane resin represented by the following average unit formula (2):
(R⁵₃SiO_{1/2})_{g}(R⁴R⁵SiO_{2/2})ₕ(R⁵₂SiO_{2/2})ᵢ(R⁵SiO_{3/2})ⱼ(SiO_{4/2})ₖ(R⁶O_{1/2})ₗ (2)
wherein R⁴ is an alkenyl group having 2 to 10 carbon atoms; R⁵ is an alkyl group having 1 to 10 carbon atoms, a cycloalkyl group having 3 to 10 carbon atoms, or an aryl group having 6 to 12 carbon atoms, with the proviso that at least 40 mol % of R⁵ are aryl groups; R⁶ is a hydrogen atom or an alkyl group having 1 to 10 carbon atoms; “g” is a number of 0 to 0.2, “h” is a number of 0.05 to 0.3, “i” is a number of 0 to 0.3, “j” is a number of 0.4 to 0.9, “k” is a number of 0 to 0.2, “l” is a number of 0 to 0.05, with the proviso that the sum of “g” to “k” is 1;
0 to 15% by mass of (A-3) an organopolysiloxane represented by the following average formula (3):
R⁷₃SiO—(R⁷₂SiO)ₙ—SiR⁷₃ (3)
wherein R⁷ is an alkenyl group having 2 to 10 carbon atoms, an alkyl group having 1 to 10 carbon atoms, a cycloalkyl group having 3 to 10 carbon atoms, or an aryl group having 6 to 12 carbon atoms, with the proviso that at least two R⁷ in a molecule are alkenyl groups, at least 30 mol % of R⁷ are aryl groups; and “n” is an integer of 4 to 100;
(B) an organohydrogenpolysiloxane having two hydrogen atoms each directly bonded to silicon atoms in a molecule, in an amount that component (B) gives 0.5 to 10 silicon atom-bonded hydrogen atoms per one alkenyl group in component (A);
(C) a hydrosilylation catalyst in a sufficient amount to conduct a hydrosilylation of the composition; and
(D) a phosphor in an amount of 25 to 400 parts by mass per 100 parts by mass of the sum of components (A), (B) and (C).

2. The curable silicone composition of claim 1, further comprising a reaction inhibitor in an amount of 0.0001 to 5 parts by mass per 100 parts by mass of the sum of components (A) and (B).

3. The curable silicone composition of claim 1, further comprising an adhesion-imparting agent in an amount of 0.01 to 10 parts by mass per 100 parts by mass of the sum of components (A) and (B).

4. The curable silicone composition of claim 1, as a curable hotmelt film.

5. A curable hotmelt film prepared by half curing of the composition according to claim 1, as determined by a reaction conversion of the hydrosilylation reaction as measured by DSC measurement.

6. The curable hotmelt film of claim 5, wherein a cure reaction conversion from the composition before half curing is 80 to 90%.

7. The curable hotmelt film of claim 5, wherein a fully cured material from the film exhibits 30 or more of Durometer D hardness.

8. The curable hotmelt film of claim 5, as a light-emitting semiconductor device.

9. The curable silicone composition of claim 1, comprising 2 to 10% by mass of component (A-3).

10. The curable silicone composition of claim 1, comprising 80 to 97% by mass of component (A-1), 1 to 5% by mass of component (A-2), and 2 to 10% by mass of component (A-3).

11. The curable silicone composition of claim 1, wherein component (B) is present in the composition in an amount that gives 0.7 to 2 silicon atom-bonded hydrogen atoms per one alkenyl group in component (A).

12. The curable silicone composition of claim 9, wherein component (B) is present in the composition in an amount that gives 0.7 to 2 silicon atom-bonded hydrogen atoms per one alkenyl group in component (A).

13. The curable silicone composition of claim 10, wherein component (B) is present in the composition in an amount that gives 0.7 to 2 silicon atom-bonded hydrogen atoms per one alkenyl group in component (A).

14. The curable silicone composition of claim 1, wherein component (A) consists essentially of component (A-1), component (A-2), and component (A-3).

15. The curable silicone composition of claim 2, further comprising an adhesion-imparting agent in an amount of 0.01 to 10 parts by mass per 100 parts by mass of the sum of components (A) and (B).
